(19) United States
(12) Patent Application Publication
(10) Pub. No.: US 2015/0204502 A1
(43) Pub. Date: Jul. 23, 2015

(54) DEVICE AND METHOD FOR ADJUSTING A HEADLIGHT

(71) Applicant: Hella KGaA Hueck & Co., Lippstadt (DE)

(72) Inventors: Michael Kleinkes, Marl (DE); Ulrich Knaack, Paderborn (DE); Christian Schmidt, Paderborn (DE)

(21) Appl. No.: 14/601,904

(22) Filed: Jan. 21, 2015

(30) Foreign Application Priority Data
Jan. 23, 2014 (DE) 102014100727.1

(51) Int. Cl. F21S 8/10

(52) U.S. Cl. CPC F21S 48/1742; F21W 2101/10

(57) ABSTRACT

An adjusting device for headlights which has adjustment means for adjusting a light distribution having a cut-off line to a predetermined position. The headlight has a matrix of semi-conductor-based light sources and an optical unit arranged in the main direction of the beam in front of the light sources for reproducing the light sources as a number of adjacent light spots which form the light distribution. First adjustment means are provided for aligning a vertical cut-off line of the light distribution in a vertical reference line on a screen arranged at a distance from the headlight. Second adjustment means are provided so that the vertical cut-off line of the light distribution can be displaced by a horizontal adjustment path, which is smaller than a horizontal width of a light spot limiting the vertical cut-off line.

### CROSS REFERENCE

This application claims priority to German Application No. 10 2014 100727.1, filed Jan. 23, 2014, which is hereby incorporated by reference.

### FIELD OF TECHNOLOGY

The invention relates to an adjusting device for headlights which has adjustment means for adjusting a light distribution having a cut-off line to a predetermined position, wherein the headlight has a matrix of semi-conductor-based light sources and an optical unit arranged in the main direction of the beam in front of the light sources for reproducing the light sources as a number of adjacent light spots which form the light distribution, wherein first adjustment means are provided for aligning a vertical cut-off line of the light distribution in a vertical reference line on a screen arranged at a distance from the headlight.

Furthermore, the invention relates to a method for adjusting a headlight, wherein the light sources of the headlight arranged on a matrix are reproduced as a number of adjacent light spots of a light distribution, that the headlight is swiveled in horizontal direction or the matrix of light sources is displaced to the extent that a vertical cut-off line of the light distribution is aligned on a vertical reference line of a screen.

### BACKGROUND

DE 10 2009 021 113 A1 discloses a headlight for motor vehicles which consists of a matrix of semi-conductor-based light sources, as well as an optical unit arranged in the main direction of the beam in front of the light sources. By means of the optical unit, the individual light sources are reproduced as a predetermined light distribution, wherein the light distribution is formed by light spots disposed adjacent to one another. To improve the use of the adaptive light function, it is provided there that optical axes of the vehicle headlight are swiveled to the outside. As a result, it is easy to reduce the angular range of the headlight to be illuminated.

DE 102 38 792 A1 discloses an adjusting device for a headlight. The adjusting device comprises adjustment means (adjusting screws) arranged at different support points to bring the headlight for a basic setting into a target position by swiveling the headlight about a horizontal and/or vertical axis. In this target position, the light distribution produced by the headlight has a predetermined cut-off line with an increase of, for example, 15%. The light source of said well-known headlight involves a gas discharge or halogen lamp. Newer headlights have LED light sources, which are arranged in matrix-like fashion on a mutual substrate in the form of one or multiple chips. In front of the matrix of light sources, an optical unit is mounted, which reproduces the individual light sources as a number of light spots disposed adjacent to one another. The group of adjacent light spots forms the desired light distribution, which can be provided, for example, as asymmetric low beam light distribution with a 15% increase. Because of the fact that the light spots appear virtually discreet in the form of pixels with a constant horizontal width b on a screen (see FIG. 1), it is not possible to implement the 15% increase with a limited number of light sources. If the light sources of the headlight are controlled in such a way that a vertical cut-off line of the light distribution extends along this vertical line V, which is brought in alignment with a left side flank of a light spot 6.1 of a vertical line V used as a reference line, the light measurement values in the offset range of the coordination system would be exceeded. When the light source responsible for the light spot 1 is switched off, the vertical cut-off line 7.1 of the light distribution 12 is displaced to the right by the horizontal width b of the light spot 6. This process has the disadvantage that the light distribution is displaced too far to the right, which results in poor illumination of the road on which the vehicle having this headlight is moving.

### SUMMARY OF THE INVENTION

Therefore, the invention has the objective of providing an adjusting device for a headlight, or a method for adjusting the headlight, to be able to adjust in a simple manner and more effectively a headlight comprising a matrix of light sources.

To solve this problem, the invention is characterized in that the vertical cut-off line of the light distribution can be displaced by a horizontal adjustment path, which is smaller than a horizontal width of a light spot limiting the vertical cut-off line.

According to the invention, second adjustment means are provided for the purpose of displacing in a desired manner a vertical cut-off line of a light distribution in horizontal direction to the extent that an optimum illumination of the area in front of the vehicle is ensured while still complying with the legal requirements. The invention is based on the idea, by means of adjustment means, to move the headlight and/or merely the matrix of light sources in such a way that the vertical cut-off line of the light distribution can be varied by the adjustment path in horizontal direction, wherein the adjustment path measures less than a horizontal width of at least the light spot limiting the vertical cut-off line. Advantageously, the vertical cut-off line of the light distribution can be displaced to a region in which an optimum illumination of the area in front of the vehicle is ensured while still complying with the legal requirements with regard to brightness. Advantageously, the headlight can be exactly adjusted, wherein the vertical cut-off line can be arranged between two light spots otherwise adjoining discreet side flanks.

According to a preferred embodiment of the invention, the second adjustment means have the effect that the light distribution is displaced to the right by the adjustment path into a second adjustment position, which is defined to be the target position for the headlight. The second adjustment means affect the headlight when the headlight is in a first adjustment position into which it was brought by means of first adjustment means by aligning the vertical cut-off line of the light distribution with the vertical reference line of the screen. By means of this basic two-step adjustment, it is easy to achieve a defined basic adjustment, which is the same in each headlight of the same type. In this way, a susceptibility to errors or incorrect adjustments can be definitely avoided.

According to a further development of the invention, the second adjustment means are designed in such a way that they have an effect on the headlight in that the light distribution of the headlight is displaced by an adjustment path that is half as wide as the width of the light spot and/or all light spots comprising the vertical cut-off line, when they have the same width. In this way, it is possible to improve the adjustment of the headlight between two discreet adjustment spots, namely exactly between two discreet adjustment spots.

According to a further development of the invention, the second adjustment means are designed in such a way that the entire headlight can be swiveled along a pivoting angle about a vertical axis so that the vertical cut-off line is displaced horizontally by the adjustment path. Therefore, the second adjustment means can extend the setting principles used already with the first adjustment means.

According to a further development of the invention, the second adjustment means merely have an effect on the matrix of light sources in such a way that through a horizontal displacement of said matrix of light sources, the vertical cut-off line is displaced by the adjustment path to a target position.

To solve the problem, the invention-based method is characterized in that in a second step the headlight or its light sources are additionally adjusted in such a way that the vertical cut-off line of the light distribution is displaced by a predetermined horizontal adjustment path which is smaller than a horizontal width of the light spot comprising the vertical cut-off line.

The special advantage of the invention-based method consists of the fact that by means of a two-step adjustment it is easy to bring a headlight, provided with a matrix of light sources into a defined target position. In a first step, the headlight is affected in such a way that a vertical cut-off line of the light distribution caused by the headlight is aligned with a vertical reference line of the screen. For example, this can be performed by a mechanic using mechanical adjustment means. In a second step, the headlight is affected in such a way that the vertical cut-off line is displaced by a predetermined horizontal adjustment path, resulting in the fact that the headlight is situated in the target position. The adjustment path is measured in such a way that it is smaller than a horizontal width of the light spot comprising the vertical cut-off line. Advantageously, in this way the vertical cut-off line can be arranged between two light spots otherwise adjoining discreet side flanks.

According to a further development of the invention-based method, in a first step, the vertical cut-off line of the light distribution is aligned with a vertical reference line so that, in the second step, the headlight is displaced into the optimum target position in that the light distribution is moved to the right by the adjustment path of the headlight. The two-step adjustment method allows for a robust and always equal basic setting of the headlight.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a partial schematic view of an asymmetric low beam light distribution when the headlight has a conventional basic setting,

FIG. 2 is a perspective frontal view of an invention-based headlight, and

FIG. 3 is a partial schematic view of an asymmetric low beam light distribution according to an invention-based basic setting.

### DETAILED DESCRIPTION OF THE DRAWINGS

An invention-based adjusting device is used for a headlight 1 which basically consists of a matrix 2 of semi-conductor-based light sources and an optical unit 4 arranged in the main direction of the beam H in front of the light sources. The semiconductor-based light sources 3 are designed in the form of LED light sources, which are arranged in two horizontal lines and a plurality of vertical columns on a mutual substrate. The LED light sources 3 can be arranged on one or multiple chips.

The light sources 3 arranged in matrix-like fashion are located directly in front of elements with stripe pattern.

Basically, the optical unit 4 consists of a single lens, which reproduces the light sources as a number of light spots. On a screen arranged at a distance to the headlight 1 the light spots 6 extend in the form of rectangles having vertical flanks 7 and horizontal flanks 8. The light spots 6 have a pixel-like design. The light spots 6 are arranged in two lines and multiple columns on a screen, without having any gaps between adjacent light spots 6. Preferably, a vertical flank 7 on one light spot 6 is aligned with the vertical flank 7 of the adjoining light spot 6.

For producing a predetermined light distribution (target light distribution), for example, an asymmetric low beam light distribution AL, the respective light sources 3 are switched on or off by means of a control unit (not shown). Because of the fact that the light spots 6 on the screen have a rectangular shape and horizontal width b and because of the low discretization level, it is not possible for the low beam light distribution AL to maintain an oblique cut-off line 9 (15° increase), especially in an offset range of a coordination system having a vertical line V and a horizontal line H.

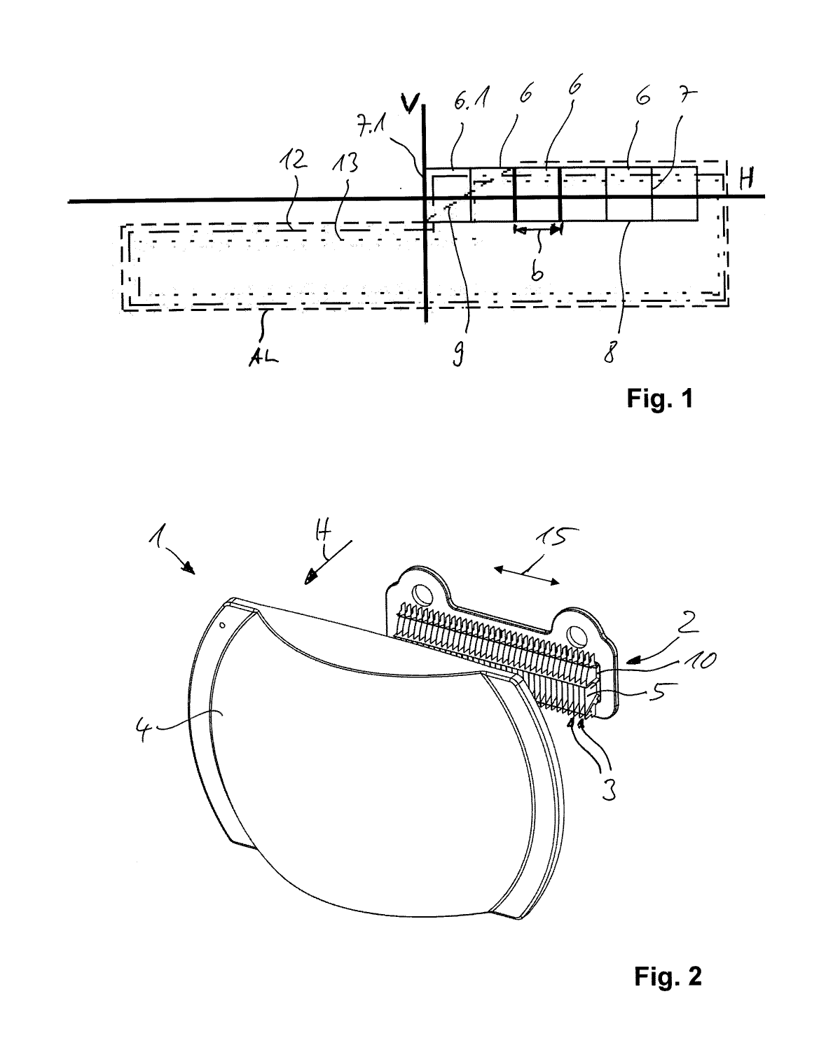

In addition, there is the problem that the invention-based headlight has to be adjusted with the light sources 3 arranged in matrix-like fashion for a basic setting in a target position to ensure optimum illumination, without dazzling a traffic object located in front of the vehicle. To ensure a definite and repeatable basic setting, it is known to align a vertical flank 7.1 of a light spot 6.1, which forms a left end of an upper line 10 of the light spot 6, on a reference line formed by the vertical line V. In the process, the flank 7.1 at the end of the light spot 6.1 is aligned with the vertical line V so that a light distribution 12 according to FIG. 1 is produced. At the same time, the flank 7.1 of the light spot 6.1 forms a vertical cut-off line 7.1 of the light distribution 12. However, the light spot 6.1 projects above the predetermined cut-off line 9 of the low beam light distribution AL to the extent that light measuring values are exceeded. If the light source 3 producing the light spot 6.1 would be switched off, the vertical cut-off line 7.1 would be displaced to the right by the width b of the light spot 6.1, resulting in a light distribution according to FIG. 1. This light distribution 13 fulfills the legal requirements with regard to not exceeding light measuring values. However, it would result in poor illumination of the area in front of the vehicle.

First mechanical adjustment means can be provided for the basic setting in accordance with light distribution 12, as well as light distribution 13. By means of these first adjustment means, the entire headlight can be swiveled about a vertical axis to the extent that the vertical flank 7 of the left light spot 6.1 at the end is aligned with the vertical line V. As disclosed in DE 102 38 792 A1, these first adjustment means can involve threaded rods or adjusting screws which engage in a support of the headlight 1.

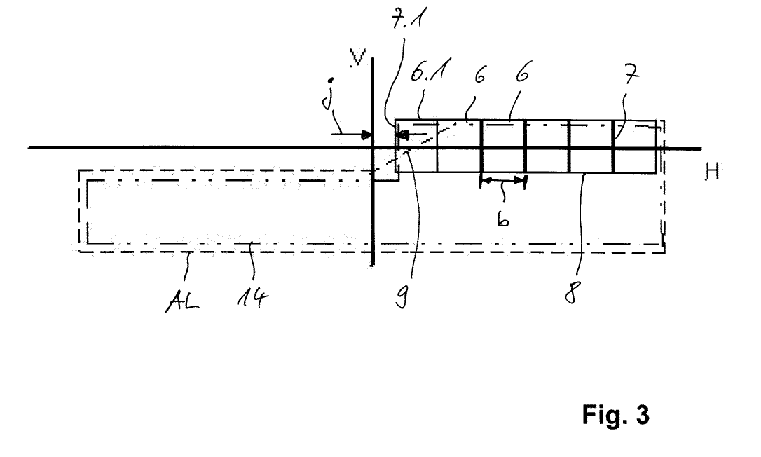

According to the invention, second adjustment means are provided by means of which the vertical cut-off line 7.1 of the light spot 6.1, as well as the second light sports 6 of light distribution 12, are displaced to the right by a horizontal adjustment path j, thus producing a light distribution 14 according to FIG. 3. It is obvious that this results in a vertical cut-off line 7.1 of the light distribution 14, which is arranged between the vertical cut-off line of light distribution 12 and the vertical cut-off line of light distribution 13. In the present embodiment, the adjustment path j corresponds to half of the horizontal width b of the light spot 6.1 or further light spots having the same width b. By displacing the vertical cut-off line 7.1 to the right in comparison to the cut-off line adjusted by means of the first adjustment means, which is aligned with the vertical line V of the screen, an improved illumination of the area in front of the vehicle can be ensured, without exceeding the maximum legal light measurement values.

The second adjustment means can engage at a support of housing (not shown) of the headlight 1 and can have the effect that the headlight is swiveled about a vertical axis along a pivoting angle.

Alternatively, it is also possible that the second adjustment means engage at the matrix 2 of light sources, displacing it in linear manner in horizontal direction (see arrow 15 in FIG. 2).

The invention-based adjusting device has a two-step design. In a first step, the headlight 1 and/or the light sources 3 are adjusted in such a way that the vertical cut-off line 7.1 of the light distribution 12 is aligned with the vertical line V (see FIG. 1). As a result, the headlight 1 is in a first adjustment position.

In a second step, the second adjustment means affect the headlight 1 and/or the light sources 3 in such a way that the vertical cut-off line 7.1 of the light distribution 12 is displaced to the right by the adjustment path j so that the headlight 1 or the light sources 3 are in a second adjustment position in which the light distribution 14 is produced.

The second adjustment means can be operated in electrical or mechanical or pneumatic manner. For example, the second adjustment means can be designed as a tilting mechanism to be operated manually or as a sliding mechanism.

According to an alternative embodiment (not shown) of the invention, the adjustment path j can also involve a region of between 10% and 90% of the horizontal width b of the light spot at the end 6.1 or further light spots 6. The parameter of the adjustment path j is depending on the expected illumination level in the area in front of the vehicle.

According to an alternative embodiment (not shown) of the invention, the optical unit 4 of the headlight can also have multiple lenses.

### REFERENCE LIST

1 headlight

2 matrix

3 light sources

4 optical unit

5 elements with stripe pattern

6, 6.1 light spot

7 vertical flank

8 horizontal flank

9, 7.1 cut-off line

10 upper line

12, 13, 14 light distribution

AL low beam light distribution

j adjustment path

V vertical line

b width

1. An adjusting device for headlights comprising:
adjustment means for adjusting a light distribution having a cut-off line to a predetermined position,
a matrix of semi-conductor-based light sources and an optical unit arranged in a main direction of a beam in front of the light sources for reproducing the light sources as a number of adjacent light spots which form the light distribution,
first adjustment means for aligning a vertical cut-off line of the light distribution in a vertical reference line on a screen arranged at a distance from the headlight,
second adjustment means for displacing the vertical cut-off line of the light distribution by a horizontal adjustment path (j) which is smaller than the horizontal width (b) of a light spot limiting the vertical cut-off line.

2. The adjusting device according to claim 1, wherein by means of the first adjustment means, the headlight and/or the light sources can be brought into a first adjustment position, in which the vertical cut-off line is brought into alignment with a vertical reference line (V) of the screen and that by means of the second adjustment means, the headlight and/or the light sources can be brought into a second adjustment position, in which the vertical cut-off line of the light distribution is displaced to the right in horizontal direction by the adjustment path (j) in comparison to the reference line (V).

3. The adjusting device according to claim 1, wherein the adjustment path (j) is half as wide as the width (b) of the light spot and/or all light spots comprising the vertical cut-off line.

4. The adjusting device according to claim 1 wherein the second adjustment means impacts the headlight in such a way that the headlight can be swiveled by such a pivoting angle about a vertical axis that the vertical cut-off line of the light distribution is horizontally displaced by the adjustment path.

5. The adjusting device according to claim 1 wherein the matrix of light sources can be linearly displaced in horizontal direction by the second adjustment means to the extent that the vertical cut-off line is horizontally displaced along the adjustment path (j).

6. The adjusting device according to claim 1 wherein the second adjustment means can be operated in electrical or mechanical or pneumatic manner

7. The adjusting device according to claim 1 wherein the second adjustment means are designed as a manual tilting mechanism or a sliding mechanism.

8. The adjusting device according to claim 1 wherein the light sources are designed in the form of LED light sources, which are arranged on at least one chip.

9-10. (canceled)
